(19) United States
(12) Patent Application Publication
(10) Pub. No.: US 2014/0300299 A1
(43) Pub. Date: Oct. 9, 2014

(54) Method for Controlling an Electronically Commutated Polyphase DC Motor

(71) Applicants: Andreas Heise, Erzhausen (DE); Ralf Hartmann, Kriftel (DE); Frank Michel, Rosbach v.d. Hohe (DE); Christian Bitsch, Heppenheim (DE); Peter Stauder, Mainz (DE); Tom Kaufmann, Ippenschied (DE); Andreas Pachur, Nurnberg (DE); Burkhard Warmbier-Leidig, Alsbach-Hahnlein (DE)

(72) Inventors: Andreas Heise, Erzhausen (DE); Ralf Hartmann, Kriftel (DE); Frank Michel, Rosbach v.d. Hohe (DE); Christian Bitsch, Heppenheim (DE); Peter Stauder, Mainz (DE); Tom Kaufmann, Ippenschied (DE); Andreas Pachur, Nurnberg (DE); Burkhard Warmbier-Leidig, Alsbach-Hahnlein (DE)

(21) Appl. No.: 14/239,028

(22) PCT Filed: Aug. 1, 2012
(86) PCT No.: PCT/EP2012/065007

§ 371 Date: May 13, 2014

(30) Foreign Application Priority Data
Aug. 15, 2011 (DE) 102011080941.4

(51) Int. Cl. H02P 6/16

(52) U.S. Cl. CPC H02P 6/16
USPC 318/400.05

(57) ABSTRACT

A method for controlling a brushless DC motor (BLDC motor) having a rotor, a stator and an angle sensor and a logic circuit for generating the phase voltages of the windings depending on the phase angle of the rotor. The logic circuit access a lookup table, in which to implement commutation with block-shaped, trapezoidal, sinusoidal, sinoid-based signal waveforms. The drive values are stored for the electrical phase angle of the rotor for generating phase voltages (V_{U}, V_{V}, V_{W}) for the windings. A control unit generates configuration data for the logic circuit determine the commutation form, and depending on the form, the drive values are supplied to a PWM generator for generating control signals (V_{U}, V_{V}, V_{W}) depending on the electrical phase angle of the rotor angle, which PWM control signals can be used to control the phase currents in the windings.

### CROSS REFERENCE TO RELATED APPLICATIONS

This application claims priority to German Patent Application No. 10 2011 080 941.4, filed Aug. 15, 2011; and PCT/EP2012/065007, filed Aug. 1, 2012.

### FIELD OF THE INVENTION

The invention relates to a method for controlling an electronically commutated polyphase DC motor (also called a brushless DC or BLDC motor) with a pole number≧2 and with a winding system with a plurality of winding phases, in particular three winding phases, having a rotor, a stator and a quadrature sensor detecting the angle of the rotor. In addition, the invention relates to an apparatus for implementing the method according to the invention.

### BACKGROUND

Electronically commutated DC motors (BLDC motors) are generally known and have a rotor, for example implemented as a permanent magnet, which is driven by an excitation field moving in rotary fashion. This excitation field is produced by a, for example, three-phase winding system by virtue of the winding phases of said three-phase winding system being energized with block-shaped or sinusoidal current profiles which are phase-shifted with respect to one another.

The commutation of a BLDC motor is implemented in the standard fashion on the basis of a microprocessor-based or software-based open-loop control or closed-loop control of the individual phase currents of the windings of the winding system of the BLDC motor by virtue of use being made, in a known manner, for example, of a triple half-bridge consisting of power semiconductors for generating a plurality of currents of different phase angle and amplitude through the winding system. The power semiconductors are driven by a microprocessor, which, by means of a quadrature sensor, for example, queries the phase angle of the rotor and controls the phase currents through the winding system of the BLDC motor corresponding to this phase angle.

There are different commutation forms, starting with simple block commutation, through trapezoid-based signal waveforms, to sinusoidal and sine-based signal waveforms with overmodulation, which can be realized with algorithms and methods known per se.

The microprocessor used for controlling the BLDC motor is utilized to different extents depending on the commutation and drive methods used. The computation capacity is in this case dependent on the type of application for which the BLDC motor is used. A microprocessor has the advantage of the greatest possible flexibility, but has increased computation capacity which it needs to have available, which also results in increased costs.

Thus, DE 10 2004 030 326 A1 discloses an energization device controlling the energization of the winding system of a BLDC motor, which energization device has, in addition to a microprocessor, a block commutation module, a sine commutation module, a trapezoid commutation module and a sinoid commutation module, in each case in the form of program modules with program code which can be implemented by the microprocessor. Depending on predeterminable criteria, one of these commutation modules is activated or described afresh by means of a control device, with the result that block-shaped, sinusoidal, trapezoidal, sinoidal phase currents or free waveforms are set at the windings of the BLDC motor via full-bridge circuits, wherein all of the windings of the winding system of the BLDC motor are each drivable independently of one another.

This known control method of a BLDC motor in accordance with DE 10 2004 030 326 A1 requires an extremely high computer capacity since a microprocessor is required for the individual commutation modules, and additionally has, for controlling the BLDC motor, a control apparatus and storage means as well as program codes of program modules for implementing the control functions.

Furthermore, DE 40 41 792 A1 discloses a method for speed control of a BLDC motor, in which an incremental transducer which is coupled rigidly to the motor shaft generates tacho pulse signals, from which address signals for a read-only memory are derived. Data values relating to the amplitude profile of sinusoidal signal profiles are stored in the read-only memory, which data values are used, after digital-to-analog conversion, for energizing the motor windings. Commutation forms other than this sinusoidal commutation cannot be implemented with this known method.

The object of the invention consists in specifying a method of the type mentioned previously which can be implemented easily and allows driving of the BLDC motor with different commutation forms without a high computation capacity of a microprocessor needing to be made available. In addition, the object of the invention consists in specifying an apparatus for implementing the method according to the invention.

### SUMMARY AND INTRODUCTORY DESCRIPTION OF THE INVENTION

The first-mentioned object is achieved by a method in accordance with the present invention.

This method for controlling an electronically commutated polyphase BLDC motor with a pole number≧2 and with a winding system with a plurality of winding phases, in particular three winding phases, employs a rotor, a stator and a quadrature sensor detecting the angle of the rotor and a logic circuit for generating the phase voltages of the winding system depending on the electrical phase angle of the rotor, is, in accordance with the invention, characterized in that the logic circuit has a storage means having a lookup table, in which, in order to implement commutation with block-shaped, trapezoidal, sinusoidal, sinoid-based signal waveforms or with signal waveforms which are suitable for commutation, the associated drive values are stored depending on the electrical phase angle of the rotor for generating phase voltages for the winding system, a control unit for generating configuration data for the logic circuit is provided, wherein the configuration data determine at least the commutation form, and depending on the specific commutation form, the associated drive values are supplied from the storage means to a PWM generator for generating PWM control signals depending on the electrical phase angle of the rotor determined by means of the quadrature sensor, which PWM control signals can be used to control the phase currents in the winding system.

By virtue of the use of a logic circuit with a simple design with a storage medium having a lookup table, the most important advantage of this method according to the invention consists in the free selectability of the commutation form without additional computer power needing to be made available. By virtue of the free selectability of the commutation form, any type of BEMF (back-electromagnetic force) motors can be driven, with the result that the torque ripple of the BLDC motor to be driven can thus be kept as low as possible, in particular as far as it being eliminated completely.

During startup of the BLDC motor, the logic circuit merely needs to be configured by means of the control device, i.e. the configuration data generated by the control device depending on the requirements of the respective application of the BLDC motor also include, in addition to the commutation form, for example, the sensor resolution of the quadrature sensor and the motor pole pair number of the BLDC motor. The values of the logic circuit can also be set to default values.

In addition to the use of a single lookup table for all commutation forms, in accordance with an advantageous development of the invention, provision is also made for in each case one subtable of the lookup table to be provided for each commutation form. Thus, access can be gained quickly and easily to the drive data of a selected commutation form.

In one configuration of the invention, the drive values are stored in the lookup table with up to an increment of 0.5° el. In order that precise control of the phase currents through the winding system of the BLDC motor is possible, there are in particular significant variation possibilities in respect of the generation of signal waveforms capable of commutation.

Preferably, in accordance with a development of the invention, the drive values are stored in the lookup table for a quarter-period of an electrical period. Thus, the storage space requirement can be kept low since, in the case of mirror-symmetrical signal waveforms, the complete electrical period can be generated by mirror-imaging of the stored drive values.

In one configuration of the invention, the speed of the rotor is determined from the signals of the angular position sensor, and from the speed, a dynamic lead angle is determined by means of motor-specific coefficients and this lead angle is used to correct the electrical phase angle of the rotor.

It is thus possible to keep the field-weakening current in the BLDC motor to the value zero over the entire speed range. It is also possible in the case of low speed values to keep the field-weakening current to the value zero by changing the motor-specific coefficients in order thus to achieve a high torque. In addition, the motor-specific coefficients can be selected such that, in the case of a high speed, the BLDC motor is controlled in the field-weakening mode, with the result that relatively high speeds are achieved. These motor-specific coefficients are predetermined with the configuration data generated by the control unit for the logic circuit.

In accordance with one development, the electrical phase angle of the rotor of the BLDC motor which is corrected with the dynamic lead angle is corrected by a steady-state lead angle, and this variable determined in this way is supplied to the storage means as the present drive position. This steady-state lead angle is determined in a system-specific or requirement-specific manner in order to achieve a phase angle for the rotor which is determined as precisely as possible. Since the method according to the invention only provides open-loop control, a complex current control algorithm can thus be dispensed with.

Since in the case of sinusoidal driving of the BLDC motor the total available operating voltage is not utilized, in accordance with one configuration of the invention, it is advantageous if, in the case of commutation with sinusoidal or sine-based signal waveforms, the drive values determined by means of the lookup table are subjected to overmodulation. Thus, the available outer conductor voltage of the BLDC motor is increased.

Since in the case of a fluctuating supply voltage of the BLDC motor, the power output of said BLDC motor likewise fluctuates and no closed-loop control structure is provided for the BLDC motor, in accordance with one configuration of the invention, provision is made for the drive values to be subjected to a feedforward correction in order to counteract these effects of a fluctuating supply voltage.

A further advantageous configuration of the invention provides that a half-bridge formed from MOS field-effect transistors (or MOSFET) is assigned to each winding for controlling the phase currents of the winding system, and at the commutation times, the gate-source voltages of the MOSFETS are monitored and switchover takes place only when the gate-source voltages have reached or fallen below predetermined thresholds. This ensures that, in the case of switchover of the MOSFETS in a half-bridge, no short circuit results from the different switching times of the MOSFETS, and a dead time is inserted between the switchover times.

Alternatively, in order to prevent such a short circuit in the half-bridge, in one configuration of the invention provision is made for, in the commutation times, switchover to take place only after execution of a predetermined dead time clock number of the system clock.

Finally, in accordance with a development, the two abovementioned methods can be combined for preventing a short circuit in the half-bridges in the case of a switchover by virtue of, in the commutation times, either switchover taking place only after execution of a predetermined dead time clock number of the system clock or the gate-source voltages of the MOSFETS are monitored and switchover only taking place when the gate-source voltages have reached or fallen below predetermined thresholds and the switching times of the MOSFETS have increased. Thus, this digital dead time generation by counting the system clock is used as the minimum dead time and only when external circumstances increase the switching times of the MOSFETS, monitors the gate-source voltages, with the result that the switchover of a half-bridge is only enabled when the MOSFETS are in the safe state for switchover.

In order to generate the individual phase voltage for the winding system of the BLDC motor, in accordance with one configuration of the invention provision is made for the drive values determined by means of the lookup table to be scaled with predetermined values of setpoint voltages. The corresponding scaling values are part of the configuration data, with the result that simple adjustment to the supply voltage required for the BLDC motor is thus possible.

The second-mentioned object is achieved by an apparatus having the features of the present invention.

This apparatus is characterized substantially by the fact that the logic circuit has a storage means having a lookup table, in which, in order to implement commutation with block-shaped, trapezoidal, sinusoidal, sinoid-based signal waveforms or with signal waveforms which are suitable for commutation, the associated drive values are stored depending on the electrical phase angle of the rotor for generating phase voltages for the winding system, a control unit for generating configuration data for the logic circuit is provided, wherein the configuration data determine at least the commutation form, and depending on the specific commutation form, the associated drive values are supplied from the storage means to a PWM generator for generating PWM control signals depending on the electrical phase angle of the rotor determined by means of the quadrature sensor, which PWM control signals can be used to control the phase currents in the winding system.

With such a logic circuit according to the invention, different drive concepts with any desired selectable commutation form can be realized with little complexity using hardware, in particular without additional processor computation power.

### BRIEF DESCRIPTION OF THE DRAWINGS

The method according to the invention will be explained and described in more detail below with reference to the attached figures, in which:

FIG. 1 shows a schematic block circuit diagram of a logic circuit for driving a BLDC motor for implementing the method according to the invention,

FIG. 2 shows a partial illustration of the block circuit diagram shown in FIG. 1 with a detailed illustration of a power output stage and a winding system of the BLDC motor,

FIG. 3 shows a graph showing the drive values for 120° block commutation as a function of the electrical rotation angle of the rotor, and

FIG. 4 shows a graph showing the drive values for a sinusoidal commutation as a function of the electrical rotation angle of the rotor.

### DETAILED DESCRIPTION OF THE INVENTION

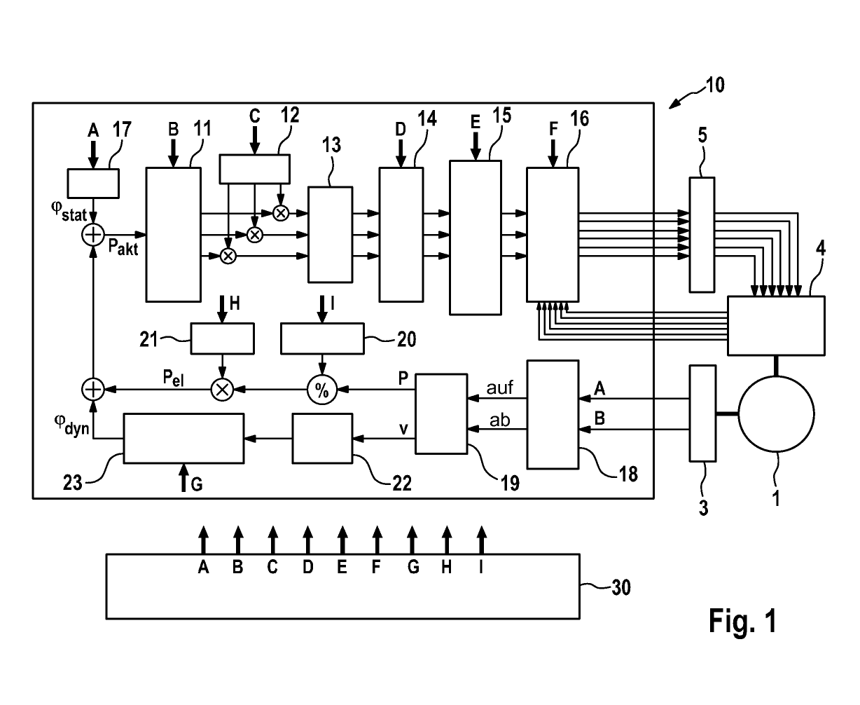

As shown in FIG. 1, a brushless DC motor (BLDC motor) 1 is driven by a power output stage 4, which is driven via a half-bridge driver circuit 5 by a logic circuit 10. This logic circuit 10 includes a plurality of function blocks 11 to 23, of which some are configured by a control unit 30 for starting up the BLDC motor 1.

In addition, the BLDC motor 1 has a quadrature sensor as angle sensor 3, which is generally in the form of a Hall sensor system or a MR (magnetic resonance) angle sensor system for detecting the position of the rotor of the BLDC motor 1. This quadrature sensor 3 is in the form of an incremental transducer and generates an A signal and a B signal, which are supplied to the logic circuit 10.

On startup of the BLDC motor 1, configuration data A to I are generated, as depicted in FIG. 1, by the control unit 30, and these configuration data are supplied to some of the function blocks 11 to 23 for configuration of the logic circuit 10, as will be set forth in more detail below. The configuration of the logic circuit 10 can also initially take place using standard values and then be changed corresponding to the application of the BLDC motor 1 via an SPI communications interface with the control unit 30.

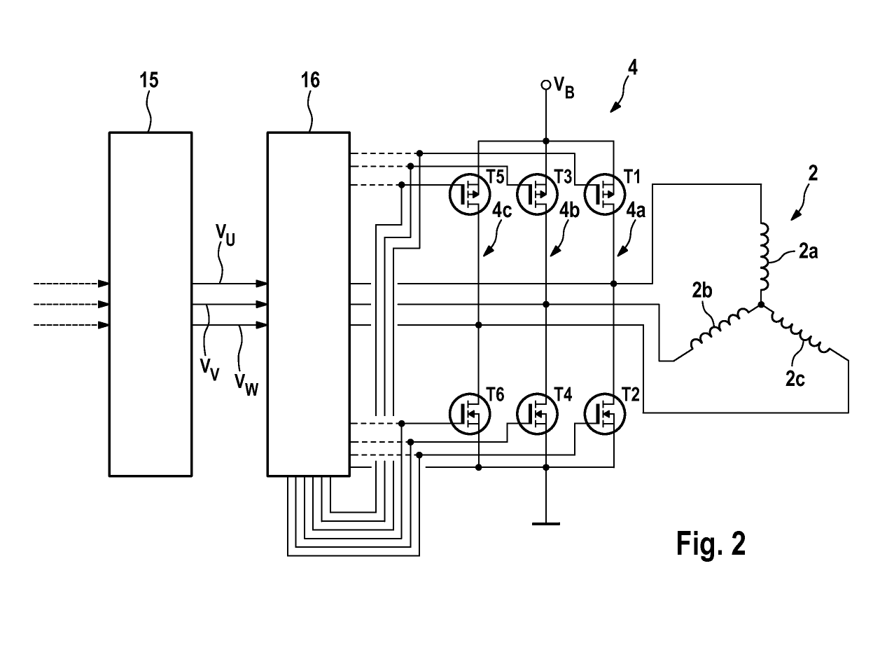

FIG. 2 shows a detailed illustration of the power output stage 4 and a winding system 2 of the BLDC motor 1. This winding system 2 of the BLDC motor 1 includes three windings 2a, 2b and 2c which are star-connected to one another, the free end windings of said windings each being connected to a half-bridge 4a, 4b includes and 4c. Each of these half-bridges 4a, 4b and 4c comprises two P-channel MOS field-effect transistors (MOSFETS) T1/T2, T3/T4 and T5/T6, which are each in the form of high-side MOSFETs and low-side MOSFETs. The gate electrodes of these MOS field-effect transistors T1/T2, T3/T4 and T5/T6 are driven via the half-bridge driver circuit 5 (not illustrated for reasons of clarity) by a function module 16, with the result that the free ends of the windings 2a, 2b and 2c can be connected to the operating voltage V_{B} or to ground.

The function blocks of the logic circuit 10 will be described below on the basis of the signals of the quadrature sensor 3.

In a quadrature decoder 18, the A signals and B signals indicating a specific rotary position of the rotor of the BLDC motor 1 are evaluated by virtue of, in corresponding states of the rotor, an increment signal or a decrement signal being passed on to a position counter 19. This position counter 19 outputs both a position signal P and a speed signal v. The position signal P is matched to the available sensor resolution by means of a sensor module 20. This sensor module 20 is configured by means of configuration data I of the control unit 30. Since this measured position value relates to the mechanical angle of the rotor of the BLDC motor 1, it is then converted by means of a pole pair module 21 to give the electrical angle Pₑₗ, which pole pair module 21 is likewise configured by the control unit 30 with configuration data H, i.e. the correct pole pair number is set.

The speed signal v is determined as the motor speed and is passed on to a function module 23 for compensating for the dynamic phase lead of the BLDC motor 1 via a filter block 22. The motor-specific phase lead is determined from the motor speed v of the BLDC motor 1 by means of this function module 23 by virtue of the value for the motor speed v being applied against configured coefficients (configuration data G of the control unit 30). These coefficients are determined in motor-specific fashion and stored in the control unit 30, with the result that the configuration of the function module 23 can be implemented corresponding to the BLDC motor 1 used.

With compensation of the dynamic phase lead of the BLDC motor 1, it is possible to keep the field-weakening current of said BLDC motor at the value zero over the entire speed range. In addition, by changing these coefficients, in the case of a low motor speed the field-weakening current can be reduced to the value zero in order thus to ensure a high torque. Finally, by corresponding selection of these coefficients, the BLDC motor 1 can be controlled in the case of high speeds in the field-weakening range in order to achieve relatively high speeds.

This function module 23 outputs a dynamic lead angle φ_{dyn}, which is added to the value Pₑₗ of the electrical angle of the rotor of the BLDC motor 1 and is then set against a steady-state lead angle φ_{steady} by means of a summing element in order to obtain the present drive position Pₚᵣₑₛ of the BLDC motor 1. A more complex current control algorithm is therefore not required.

This steady-state lead angle φ_{steady} is generated by a function module 17, which is configured by means of configuration data A of the control unit 30. This steady-state lead angle φ_{steady} is also determined in a motor-specific manner and is output as configuration data A from the control unit 30 to this function module 17 corresponding to the BLDC motor 1 used.

The present drive position Pₚᵣₑₛ represents an input value for a writable memory 11, which contains a lookup table for drive values of the BLDC motor 1.

The associated drive values are stored for each commutation form of a BLDC motor 1 used in this lookup table depending on the present drive position Pₚᵣₑₛ. Thus, the associated drive values are used for a block-shaped, trapezoidal, sinusoidal, sinoid-based signal waveform or for free signal waveforms suitable for commutation via configuration data B of the control unit 30 in order to control the BLDC motor 1 with this configured commutation form.

Thus, it is possible to drive any type of BEMF DC motor with any desired commutation form.

In mirror-symmetrical drive forms, the drive values for a commutation form in a quarter-period are stored, with the result that the entire period can be generated merely by mirroring the values of the stored quarter-period.

A subtable of the lookup table is established for each commutation form. For example, a subtable with drive values is illustrated below for 120° block commutation.

| Increments S | Phase | Phase V | Phase W |
|---|---|---|---|
| 1 | 1 | 0 | Z |
| 2 | 1 | Z | 0 |
| 3 | Z | 1 | 0 |
| 4 | 0 | 1 | Z |
| 5 | 0 | Z | 1 |
| 6 | Z | 0 | 1 |

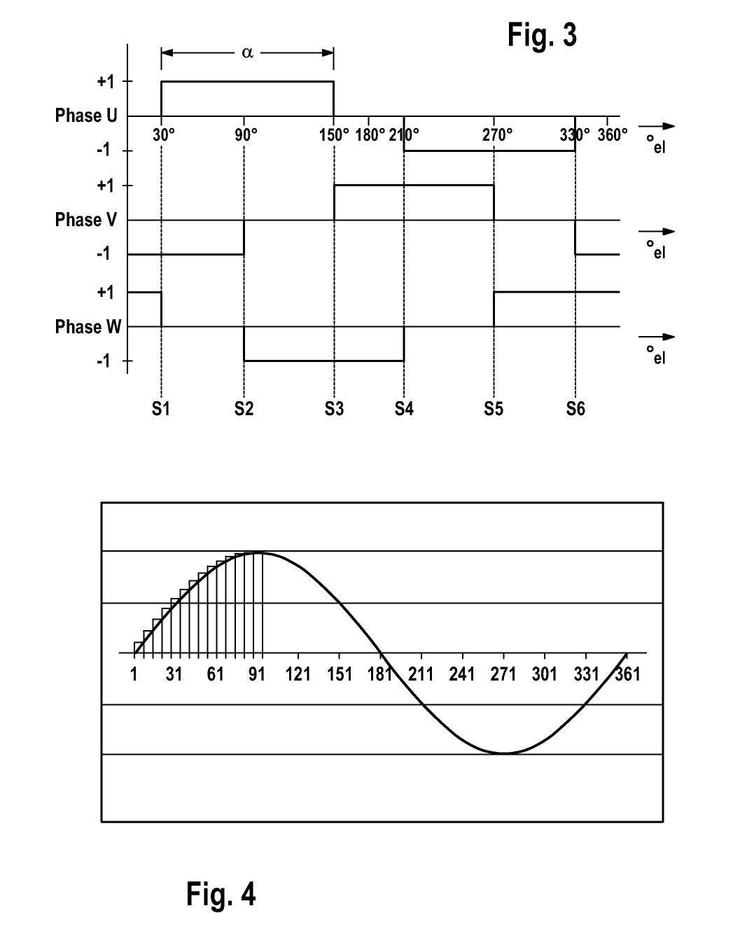

FIG. 3 shows the associated control pattern or the associated signal form for the three phases U, V and W for driving the three-phase BLDC motor 1 shown in FIG. 2 for a full electrical cycle, i.e. a full rotation of the excitation field through 360°. This full cycle is divided into 60° zones, with the result that these 60° zones are passed through in 6 increments 1 to 6. At the beginning of each such 60° zone, the MOS field-effect transistors T1/T2, T3/T4 and T5/T6 of the power output stage 4 can be switched on or off for the commutation of a phase. The state of the phase is then still maintained at least up to the end of such a 60° zone, but can have a PWM signal superimposed on it, as explained below. The commutation angle α is 120°.

The above-illustrated subtable thus defines the drive values for each of the increments S1 to S6. In this case, the inputs “1”, “0” and “Z” have the meaning “phase positive”, “phase negative” and “phase high resistance”.

Thus, with reference to FIG. 3, for example, the phase U is driven with an increment of 1, i.e. the phase U changes its logic level from “0” to “+1”, the phase V is switched off, i.e. is at logic level “−1”, and the phase W is changed to a high resistance, its status changes from “+1” to “0”.

A further example of a subtable of the lookup table is shown by the following table which contains drive values for a sinusoidal commutation with 5° increments:

| Increments/degrees | Phase U | Phase V | Phase W |
|---|---|---|---|
| 5 | 0.09 | −0.91 | 0.82 |
| 10 | 0.17 | −0.94 | 0.77 |
| 15 | 0.26 | −0.97 | 0.71 |
| 20 | 0.34 | −0.98 | 0.64 |
| 25 | 0.42 | −1.00 | 0.57 |
| 30 | 0.50 | −1.00 | 0.50 |
| 35 | 0.57 | −1.00 | 0.42 |
| 40 | 0.64 | −0.98 | 0.34 |
| 45 | 0.71 | −0.97 | 0.26 |
| 50 | 0.77 | −0.94 | 0.17 |
| . . . | . . . | . . . | . . . |
| 90 | 1 | −0.5 | −0.5 |

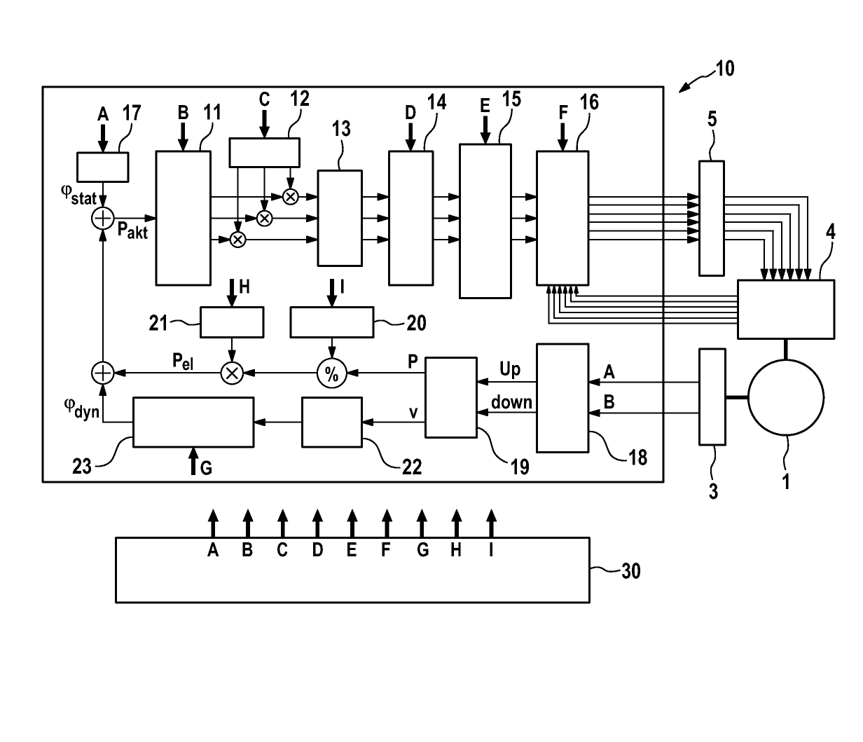

Only these values for a quarter-period are stored in the subtable since the values for the complete period can be generated by mirroring. The associated signal waveform or the associated control pattern for the first quarter-period is shown in FIG. 4 as well as the associated sine curve. It is also possible for finer granulation than 5° increments to be selected, i.e. up to an increment of 0.5°, for example.

Depending on the present drive position Pₚᵣₑₛ determined, in accordance with FIG. 1 the drive values are output by the memory 11 from the lookup table corresponding to the configured commutation form and multiplied by means of the scaling factors stored in a scaling module 12 in order to generate the individual phase voltages for the windings 2a, 2b and 2c of the winding system 2. This scaling module 12 is likewise configured with calibration data C generated by the control unit 30.

In the case of sinusoidal driving of the BLDC motor 1, the total available operating voltage V_{B} is not utilized. Therefore, the generated phase voltages are supplied to an overmodulation module 13, as a result of which the 3rd harmonic sine oscillation is added to the individual sinusoidal phase voltages. The outer conductor voltage of the BLDC motor 1 available is thus increased.

In the case of a fluctuating operating voltage, the power output, i.e. either the torque or the speed of the BLDC motor 1, is likewise fluctuating since the driving of the BLDC motor 1 shown in FIG. 1 does not include a closed-loop control structure. In order to counteract this effect, matching of the calculated phase voltage to the operating voltage V_{B}, i.e. feedforward correction, is implemented by means of a feedforward module 14.

The phase voltages generated and corrected in this way are converted into PWM control signals V_{U}, V_{V} and V_{W} with a corresponding pulse-no pulse ratio in a PWM module 15. This PWM module 15 can also provide test vectors on the individual motor phases, wherein these test vectors are predetermined by the control unit 30, for example, via a communications interface E.

Before the PWM control signals V_{U}, V_{V} and V_{W} are supplied to the power output stage 4, a dead time generation is performed by means of a short-circuit protection module 16.

In order to prevent a short circuit arising in the event of a switchover of one of the high-side MOSFETs T1, T3 or T5 to a low-side MOSFET T2, T4 or T6 as a result of the different switching times of said MOSFETs, a dead time is inserted between the switchover.

With this short-circuit protection module 16, one of three methods for dead time generation can be used, wherein the corresponding method is selected by means of configuration data F generated by the control unit 30.

The first method for dead time generation uses the system clock by virtue of counting up to a predetermined count value.

The second method is depicted in FIG. 2, in which the individual gate-source voltages of the MOS field-effect transistors T1 to T6 of the half-bridges 4a, 4b and 4c are measured and evaluated. For this purpose, as shown in FIG. 2, the gate potentials and the source potentials of the MOSFETS T1 to T6 are supplied to the short-circuit protection module 16. If these gate-source voltages fall below an adjustable threshold, switchover can take place, otherwise switchover is prevented when these voltages rise to above this threshold.

With this short-circuit protection module 16, six drive signals are generated, taking into consideration the dead time generated, from the three PWM control signals V_{U}, V_{V} and V_{W} generated by the PWM module 15, which drive signals represent the control signals for the individual MOSFETS T1 to T6.

The third method for dead time generation is a combination of the digital generation of the dead time by means of the system clock and the method for monitoring the gate-source voltages of the MOS field-effect transistors T1 to T6 (gate-source voltage method).

In this third method, the digitally generated dead time is used as minimum dead time and, only when, as a result of external circumstances, the switching times of the MOSFETS T1 to T6 are increased and therefore higher dead times are required, is the gate-source voltage method used and therefore the switchover of a half-bridge 4a, 4b or 4c is only enabled when the MOSFETS T1 to T6 are in a state which is safe for switchover.

The logic circuit 10 shown in FIG. 1 permits various drive concepts; thus, in the case of a sinusoidal commutation form, the overmodulation to be implemented by the overmodulation module 13 can be switched on, and the evaluation of the gate-source voltages for generating a dead time is also an option.

The windings 2a, 2b and 2c of the winding system 2 can also be delta-connected to one another. The half-bridges 4a, 4b and 4c can also be constructed with N-channel field-effect transistors instead of P-channel field-effect transistors.

Instead of the subtables in the exemplary embodiment described above, the values of all commutation forms can also be listed in a single lookup table.

### REFERENCE SYMBOLS

1 BLDC motor
2 winding system of BLDC motor 1
2a winding of winding system 2
2b winding of winding system 2
2c winding of winding system 2
3 angle sensor, quadrature sensor
4 power output stage comprising three half-bridges
4a half-bridge
4b half-bridge
4c half-bridge
5 half-bridge driver circuit
10 logic circuit
11 storage means, memory
12 scaling module
13 overmodulation module
14 feedforward module
15 PWM module
16 short-circuit protection module
17 function module for steady-state lead angle
18 quadrature decoder
19 position counter
20 sensor module
21 pole pair module
22 filter block
23 function module 23 for compensating for dynamic phase lead of BLDC motor 1
30 control unit
A-I configuration data
T1-T6 MOS field-effect transistors (MOSFETS)
P position signal, mechanical angle of rotor
Pₑₗ electrical angle
Pₚᵣₑₛ present drive position of BLDC motor 1
V_{B} operating voltage
v speed signal
V_{U}, V_{V}, V_{W} PWM control signals
α commutation angle
φ_{dyn} dynamic lead angle
φ_{steady} steady-state lead angle

While the above description constitutes the preferred embodiment of the present invention, it will be appreciated that the invention is susceptible to modification, variation, and change without departing from the proper scope and fair meaning of the accompanying claims.

1. A method for controlling an electronically commutated polyphase DC motor (1) with a pole number greater than two and with a winding system (2) with three winding phases, comprising
a rotor, a stator, and an angle sensor (3) for detecting the angle of the rotor, and a logic circuit (10) for generating the phase voltages of the winding system (2) depending on the electrical phase angle of the rotor,
the logic circuit (10) has a storage means (11) having a lookup table, in which, in order to implement commutation with at least one of commutation forms including a block-shaped, a trapezoidal, a sinusoidal, a sinoid-based signal waveforms or with other signal waveforms which are suitable for commutation, the associated drive values are stored depending on the electrical phase angle of the rotor for generating phase voltages (V_{U}, V_{V}, V_{W}) for the winding system (2),
a control unit (30) for generating configuration data for the logic circuit (10), wherein the configuration data determine at least the commutation form, and
depending on the commutation form, the associated drive values are supplied from the storage means (11) to a PWM generator (15) for generating PWM control signals (V_{U}, V_{V}, V_{W}) depending on the electrical phase angle of the rotor determined by means of the angle sensor (3), which PWM control signals can be used to control the phase currents in the winding system (2).

2. The method as claimed in claim 1, further comprising a subtable of the lookup table is provided for each of the at least one commutation form.

3. The method as claimed in claim 1 further comprising in that the drive values are stored in the lookup table with up to an increment of 0.5° el.

4. The method as claimed in claim 1 further comprising in that the drive values are stored in the lookup table for a quarter-period of an electrical period.

5. The method as claimed in claim 1 further comprising in that
the speed of the rotor is determined from the signals of the angular position sensor (3), and
a dynamic lead angle with which the electrical phase angle of the rotor determined by the angle sensor (3) can be corrected is determined from the speed of the rotor by means of motor-specific coefficients.

6. The method as claimed in claim 5, further comprising in that the value of the determined phase angle of the rotor, corrected by the dynamic lead angle, is corrected by a steady-state lead angle supplied to the storage means (11) as the present drive position.

7. The method as claimed in claim 1 further comprising in that, in the case of commutation with the commutation forms of the sinusoidal or the sine-based signal waveforms, the drive values determined by means of the lookup table are subjected to overmodulation.

8. The method as claimed in claim 1 further comprising in that the drive values are subjected to feedforward correction in order to counteract a fluctuating supply voltage of the motor (1).

9. The method as claimed in claim 1 further comprising
a half-bridge (4) formed from a MOSFET assigned to each winding for controlling the phase currents of the winding system (2), and
at commutation times, the gate-source voltages of the MOSFETS are monitored and switchover takes place only when the gate-source voltages have reached or fallen below a predetermined threshold.

10. The method as claimed in claim 1 further comprising
a half-bridge (4) formed from a MOSFET is assigned to each winding for controlling the phase currents of the winding system (2), and
at commutation times, switchover takes place only after execution of a predetermined dead time clock number of a system clock.

11. The method as claimed in claim 1 further comprising
a half-bridge (4) formed from a MOSFET is assigned to each winding for controlling the phase currents of the winding system (2), and
at commutation times, either switchover takes place only after execution of a predetermined dead time clock number of the system clock or the gate-source voltages of the MOSFET is monitored and switchover only takes place when the gate-source voltage have reached or fallen below a predetermined threshold and the switching times of the MOSFET has increased.

12. The method as claimed in claim 1 further comprising in that the drive values determined by means of the lookup table are scaled with predetermined values for setpoint voltages in order to generate the phase voltages for the winding system.

13. An apparatus for controlling an electronically commutated polyphase DC motor (1) with a pole number greater than two and with a winding system (2) with three winding phases, comprising
a rotor, a stator, an angle sensor (3) detecting the angle of the rotor, and a logic circuit (10) for generating the phase voltages of the winding system (2) depending on the electrical phase angle of the rotor,
the logic circuit (10) having a storage means (11) having a lookup table, in which, in order to implement at least one of commutation forms including a block-shaped, a trapezoidal, a sinusoidal, a sinoid-based signal waveforms or with signal waveforms which are suitable for commutation, the associated drive values are stored depending on the electrical phase angle of the rotor for generating phase voltages (V_{U}, V_{V}, V_{W}) for the winding system (2),
a control unit (30) generating configuration data for the logic circuit (10), wherein the configuration data determine at least the commutation form, and
depending on the commutation form, the associated drive values are supplied from the storage means (11) to a PWM generator (15) for generating PWM control signals (V_{U}, V_{V}, V_{W}) depending on the electrical phase angle of the rotor determined by means of the angle sensor (3), which PWM control signals can be used to control the phase currents in the winding system (2).

14. The apparatus as claimed in claim 13, further comprising in that a quadrature decoder (18) and a position counter (19) are provided, with which a speed signal (v) and a position signal (P) are generated.

15. The apparatus as claimed in claim 14, further comprising in that a function module (23) for compensating for the dynamic phase lead of the BLDC motor (1) is provided, to which the speed signal (v) is supplied.

16. The apparatus as claimed in claim 13 further comprising in that an overmodulation module (13) is provided.

17. The apparatus as claimed in claim 13 further comprising in that a short-circuit protection module (16) for dead time generation is provided.

18. The apparatus as claimed in claim 13 further comprising in that a feedforward module (14) for implementing a feedforward correction is provided.
